(19) United States
(12) Patent Application Publication
(10) Pub. No.: US 2026/0322566 A1
(43) Pub. Date: Oct. 15, 2026

(54) SYSTEMS, APPARATUSES AND METHODS FOR INDICATING EXTENDED DISTRIBUTED RESOURCE UNIT BANDWIDTH

(71) Applicant: HUAWEI TECHNOLOGIES CO., LTD., SHENZHEN (CN)

(72) Inventors: Jung Hoon SUH, Kanata (CA); Yan XIN, Kanata (CA); Mahmoud HASABELNABY, Kanata (CA); Osama ABOUL-MAGD, Kanata (CA); Sara NOROUZI, Kanata (CA); Abdalla Mohamed Abdelaziz Mahmoud HUSSEIN, Kanata (CA); Kwok Shum AU, Kanata (CA)

(73) Assignee: HUAWEI TECHNOLOGIES CO., LTD., SHENZHEN (CN)

(21) Appl. No.: 19/175,732

(22) Filed: Apr. 10, 2025

(51) Int. Cl. H04L 5/00

(52) U.S. Cl. CPC H04L 5/0094

(57) ABSTRACT

A method and apparatus for indicating extended DRU bandwidth (DBW) and extended spatial stream (SS) allocation in a UHR variant user info field of a UHR trigger frame is provided. The at least three extended DBW bits can be used to jointly indicate extended DBW and can be used to represent a puncturing pattern of a plurality of puncturing patterns. The at least two extended SS allocation bits can be used to jointly indicate extended SS allocation and can be used to represent a spatial stream of a number of spatial streams.

### CROSS-REFERENCE TO RELATED APPLICATIONS

This application first application associated with the present disclosure.

### FIELD OF THE DISCLOSURE

The present disclosure relates generally to wireless communication systems, apparatuses, methods, and non-transitory computer-readable storage devices, and in particular to systems, apparatuses and methods for supporting scheduling of distributed resource units (DRUs) in wireless communication systems.

### BACKGROUND

Wireless communication systems such as IEEE 802.11 standard series (that is, Wi-Fi® series; Wi-Fi® is a registered trademark of Wi-Fi® Alliance, Austin, TX, USA) are known. In the recent IEEE 802.11bn standard, DRUs have been introduced. DRUs offer an advantage of boosted transmission power and improved coverage. In the IEEE 802.11bn standard, the supported DRU bandwidth (DBW) is limited to 20 MHz, 40 MHz, 60, MHz, and 80 MHz. For a 60 MHz DBW, one 60 MHz pattern in an 80 MHz frequency subblock is supported with a single puncturing pattern in the IEEE 802.11bn standard.

Therefore, there is a need for a method, apparatus and system for wireless communication that obviates or mitigates one or more limitations of the prior art.

This background information is provided to reveal information believed by the applicant to be of possible relevance to the present disclosure. No admission is necessarily intended, nor should be construed, that any of the preceding information constitutes prior art against the present disclosure.

### SUMMARY

According to an aspect of the present disclosure, there is provided a method that includes forming, at a first device in a wireless network, an ultra-high reliability (UHR) trigger frame having a UHR variant user info field. The UHR variant User Info field includes at least three extended distributive resource unit bandwidth (DBW) bits. The at least three extended DBW bits are jointly representing an extended DBW. The UHR variant user info field includes at least two extended spatial stream (SS) allocation bits. The extended SS allocation bits are jointly representing an extended SS to be used by a second device in the wireless network. The method includes transmitting, by the first device, the UHR trigger frame to the second device.

According to an aspect of the present disclosure, there is provided a method that includes receiving, at a first device in a wireless network, an ultra-high reliability (UHR) trigger frame having a UHR variant user info field. The UHR variant user info field includes at least three extended distributive resource unit bandwidth (DBW) bits. The at least three extended DBW bits are jointly representing an extended DBW. The UHR variant user info field includes at least two extended spatial stream (SS) allocation bits. The at least two extended SS allocation bits are jointly representing an extended SS to be used in transmitting, by the first device, a trigger based (TB) physical layer protocol data unit (PPDU) based on the UHR trigger frame. The method includes transmitting, by the first device, the TB PPDU, to a second device in the wireless network.

According to an aspect of the present disclosure, there is provided an apparatus in a wireless network. The apparatus includes a processor and memory, the memory including machine executable instructions which when executed by the processor configure the apparatus to form, at a first device in a wireless network, an ultra-high reliability (UHR) trigger frame having a UHR variant user info field. The UHR variant user info field includes at least three extended distributive resource unit bandwidth (DBW) bits. The at least three extended DBW bits are jointly representing an extended DBW. The UHR variant User Info field includes at least two extended spatial stream (SS) allocation bits. The at least two extended SS allocation bits are jointly representing an extended SS to be used by a second device in the wireless network. The machine executable instructions, when executed by the processor, further configure the apparatus to transmit, by the first device, the UHR trigger frame to the second device.

In some embodiments, the at least three extended DBW bits may include bit 27 and bit 28 and one of bit 29 and bit 30. The at least three extended DBW bits may be indicative of a puncturing pattern selected from a plurality of puncturing patterns. The puncturing pattern may be associated with a bandwidth (BW) indicated in the UHR trigger frame. The plurality of puncturing patterns may include 8 distinct puncturing patterns.

In some embodiments, a bit may be selected from bit 29 and bit 30. The selected bit may be absent from the at least three extended DBW bits. The at least two extended SS allocation bits may include bit 31 of the UHR variant user info field and the selected bit.

In some embodiments, the at least three extended DBW bits may include bit 27 and bit 28 and bit 29 and bit 30. The at least three extended DBW bits may be indicative of a puncturing pattern selected from a plurality of puncturing patterns. The puncturing pattern may be associated with a bandwidth (BW) indicated in the UHR trigger frame. The plurality of puncturing patterns may include 16 distinct puncturing patterns.

In some embodiments, one bit may be selected from bit 32 through bit 38. The at least two extended SS allocation bits may include bit 31 of the UHR variant user info field and the selected bit. The selected bit may be bit 32.

In some embodiments, the extended DBW bits are contiguous.

According to one aspect of this disclosure, there is provided one or more circuits such as one or more processors for performing the above-described methods.

According to one aspect of this disclosure, there is provided one or more processors functionally connected to one or more memories for performing the above-described methods.

According to one aspect of this disclosure, there is provided an apparatus including one or more processors functionally connected to one or more memories for performing the above-described methods.

According to one aspect of this disclosure, there is provided one or more non-transitory computer-readable storage devices including computer-executable instructions, wherein the instructions, when executed, cause one or more circuits to perform the above-described methods.

According to one aspect of this disclosure, there is provided an apparatus, and configured to perform any one of the above mentioned methods and their embodiments. Specifically, the apparatus includes one or more units configured to perform any one of the above mentioned methods and their embodiments.

According to one aspect of this disclosure, there is provided a computer-readable storage medium. The computer-readable storage medium stores a computer program, and when the computer program is executed by an apparatus, the apparatus is enabled to implement any one of the above mentioned methods and their embodiments.

According to one aspect of this disclosure, there is provided a computer program product including one or more instructions. When the instructions are executed by an apparatus such as a computer, the apparatus is enabled to implement any one of the above mentioned methods and their embodiments.

According to one aspect of this disclosure, there is provided a computer program. When the computer program is executed by a computer, an apparatus is enabled to implement any one of above mentioned methods and their embodiments.

According to one aspect of this disclosure, there is provided a communication system. The communication system includes a first communication-node and/or a second communication-node, the first communication-node is configured to perform the methods regarding with the first communication-node as stated above, and the second communication-node is configured to perform the methods regarding with the second communication-node as stated above.

According to one aspect of this disclosure, there is provided an apparatus for implementing the methods in any possible implementation of the foregoing aspects.

Embodiments have been described above in conjunctions with aspects of the present disclosure upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present disclosure will become apparent from the following detailed description, taken in combination with the appended drawings, in which:

FIG. 1 is a simplified schematic diagram showing a communication system, according to some embodiments of this disclosure.

FIG. 2 is a simplified schematic diagram of an access point (AP) of the communication network of the communication system shown in FIG. 1.

FIG. 3 is a simplified schematic diagram of a station (STA) of the communication system shown in FIG. 1.

FIG. 4 is a simplified schematic diagram of a UHR variant common info field of a trigger frame.

FIG. 5 is a simplified schematic diagram of a UHR variant user info field of a trigger frame.

FIG. 6 is a simplified schematic diagram of an Indication of DBW and number of SS in the UHR variant user info field.

FIG. 7A is a simplified schematic diagram of a UHR variant user info field having three extended DBW bits and two extended SS allocation bits, according to an embodiment of the present disclosure.

FIG. 7B is a simplified schematic diagram of a UHR variant user info field having three extended DBW bits and two extended SS allocation bits, according to another embodiment of the present disclosure.

FIG. 7C is a simplified schematic diagram of a UHR variant user info field having four extended DBW bits and one SS allocation bit, according to an embodiment of the present disclosure.

FIG. 7D is a simplified schematic diagram of a UHR variant user info field having four extended DBW bits and two SS allocation bits, according to an embodiment of the present disclosure.

FIG. 8A is a table showing an example indication of the extended DBW and its puncturing patterns using three extended DBW bits, according to an embodiment of the present disclosure.

FIG. 8B is a table showing an example indication of the extended DBW and its puncturing patterns using four extended DBW bits, according to an embodiment of the present disclosure.

FIG. 9 illustrates a first example method, according to embodiments of the present disclosure.

FIG. 10 illustrates a second example method, according to embodiments of the present disclosure.

It will be noted that throughout the appended drawings, like features are identified by like reference numerals.

### DETAILED DESCRIPTION

Embodiments disclosed herein relate to systems, apparatuses, methods, and non-transitory computer-readable storage devices for wireless communication. The wireless communication systems, apparatuses, and methods disclosed herein may be any suitable systems, apparatuses, and methods for transmitting wireless signals. Examples of such systems may be wireless local-area network (WLAN) ultra-high reliability (UHR) systems (for example, IEEE 802.11bn or Wi-Fi® 8 systems and future Wi-Fi® systems), 5G or 6G wireless mobile communication systems, and the like.

In a wireless network, an access point (e.g., a wireless access point (AP)), may form and transmit trigger frames to other devices (e.g., stations (STAs)) in the wireless network indicating which regular resource units (RRUs) and/or which distributive resource units (DRUs) to use in device's transmit and receive operations in the wireless network. The transmission in the wireless network may be, for example, over the low power indoor channel of 6 GHz frequency band.

The DRU is introduced in the IEEE 802.11bn standard which supports DRU BW (DBW) that is limited to 20 MHz, 40 MHz, 60 MHz, and 80 MHz. In case of 60 MHz DBW, only one 60 MHz puncturing pattern in an 80 MHz frequency subblock is supported in IEEE 802.11bn standard.

Embodiments of the present disclosure pertain to methods and apparatuses to indicate the extended DBW and its extended puncturing patterns in the UHR trigger frame. Reserved bits in the current UHR variant user info field may be utilized, in addition to the existing DBW subfield bits in the UHR variant user info field, for the indication of the extended DBW and its extended puncturing patterns. One or more of the reserved bits in the UHR variant user info field may be utilized, optionally in addition to another one or more bits from other subfields of the UHR variant user info field, for the indication of the extended spatial stream (SS) allocation. Embodiments disclosed herein advantageously facilitate a transmit (TX) power enhancement with the DRU in a highly limited channel in TX power. Various embodiments may be implemented in devices in the wireless network, such as APs and STAs, for example by configuring thereof according to embodiments to perform one or more methods disclosed herein.

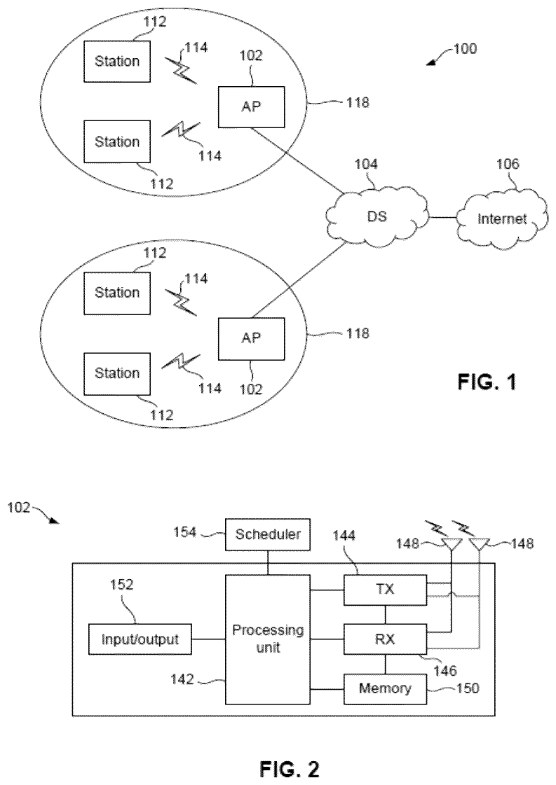

Turning now to FIG. 1, a communication system according to some embodiments of this disclosure is shown and is generally identified using reference numeral 100. As an example, the communication system 100 may be a Wi-Fi® system built under relevant standards such as IEEE 802.11 standard. As shown, the communication system 100 includes a plurality of interconnected networking devices 102 such as a plurality of interconnected access points (APs; also called “base stations”) forming a distribution system (DS) 104 which is in turn connected to other networks such as the Internet 108 which may include a network of computers and subnets (intranets) or both, and incorporate protocols, such as Internet protocol (IP), transmission control protocol (TCP), user datagram protocol (UDP), and/or the like.

Each AP 102 is in wireless communication with one or more mobile or stationary stations 112 (STAs) through respective wireless channels 114 for providing wireless network connects thereto. Herein, the APs 102 and STAs 112 may be considered as different types of network nodes (or simply “nodes”) of the communication system 100. Each AP 102 and the STAs 112 connected thereto form a cell or basic service set (BSS) 118.

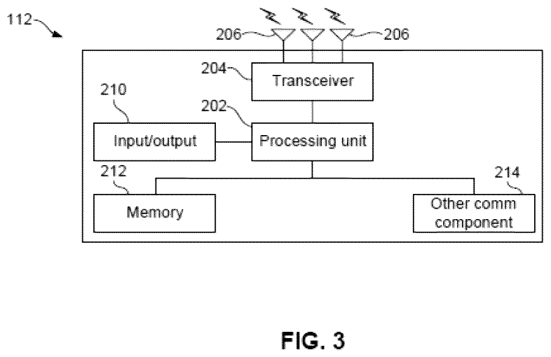

FIG. 2 is a simplified schematic diagram of an AP 102. As shown, the AP 102 includes at least one processing unit 142 (also denoted at least one “processor”), at least one transmitter (Tx) 144, at least one receiver (RX) 146 (collectively referred to as a transceiver), one or more antennas 148, at least one memory 150, and one or more input/output components or interfaces 152. A scheduler 154 may be coupled to the processing unit 142. The scheduler 154 may be included within or operated separately from the AP 102. Each of these components 142 to 154 may be implemented as one or more circuits (such as one or more electronic circuits and/or one or more optical circuits). Alternatively, the ensemble of these components 142 to 154 may be implemented as one or more circuits.

The processing unit 142 Is configured for performing various processing operations such as signal coding, data processing, power control, input/output processing, or any other suitable functionalities. The processing unit 142 may include a microprocessor, a microcontroller, a digital signal processor, a field programmable gate array (FPGA), an application specific integrated circuit (ASIC), and/or the like. In some embodiments, the processing unit 142 may execute computer-executable instructions or code stored in the memory 150 to perform various the procedures (otherwise referred to as methods) described below.

Each transmitter 144 may include any suitable structure for generating signals, such as control signals as described in detail below, for wireless transmission to one or more STAs 112. Each receiver 146 may include any suitable structure for processing signals received wirelessly from one or more STAs 112. Although shown as separate components, at least one transmitter 144 and at least one receiver 146 may be integrated and implemented as a transceiver. Each antenna 148 may include any suitable structure for transmitting and/or receiving wireless signals. Although common antennas 148 are shown in FIG. 2 as being coupled to both the transmitter 144 and the receiver 146, one or more antennas 148 may be coupled to the transmitter 144, and one or more other antennas 148 may be coupled to the receiver 146.

In some embodiments, an AP 102 may include a plurality of transmitters 144 and receivers 146 (or a plurality of transceivers) together with a plurality of antennas 148 for communication in its cell 118.

Each memory 150 may include any suitable volatile and/or non-volatile storage such as RAM, ROM, hard disk, optical disc, SIM card, solid-state memory, memory stick, SD memory card, and/or the like. The memory 150 may be used for storing instructions executable by the processing unit 142 and data used, generated, or collected by the processing unit 142. For example, the memory 150 may store instructions of software, software systems, or software modules that are executable by the processing unit 142 for implementing some or all of the functionalities and/or embodiments of the procedures performed by an AP 102 described herein.

Each input/output component 152 enables interaction with a user or other devices in the communication system 100. Each input/output device 152 may include any suitable structure for providing information to or receiving information from a user and may be, for example, a speaker, a microphone, a keypad, a keyboard, a display, a touch screen, a network communication interface, and/or the like.

Herein, the STAs 112 may be any suitable wireless device that may join the communication system 100 via an AP 102 for wireless operation. In various embodiments, a STA 112 may be a wireless electronic device used by a human or user (such as a smartphone, a cellphone, a personal digital assistant (PDA), a laptop, a desktop computer, a tablet, a smart watch, a consumer electronics device, and/or the like). A STA 112 may alternatively be a wireless sensor, an Internet-of-things (IoT) device, a robot, a shopping cart, a vehicle, a smart TV, a smart appliance, a wireless transmit/receive unit (WTRU), a mobile station, or the like. Depending on the implementation, the STA 112 may be movable autonomously or under the direct or remote control of a human, or may be positioned at a fixed position.

In some embodiments, a STA 112 may be a multimode wireless electronic device capable of operation according to multiple radio access technologies and incorporate multiple transceivers necessary to support such.

In addition, some or all of the STAs 112 include functionality for communicating with different wireless devices and/or wireless networks via different wireless links using different wireless technologies and/or protocols. Instead of wireless communication (or in addition thereto), the STAs 112 may communicate via wired communication channels to other devices or switches (not shown), and to the Internet 106. For example, a plurality of STAs 112 (such as STAs 112 in proximity with each other) may communicate with each other directly via suitable wired or wireless sidelinks.

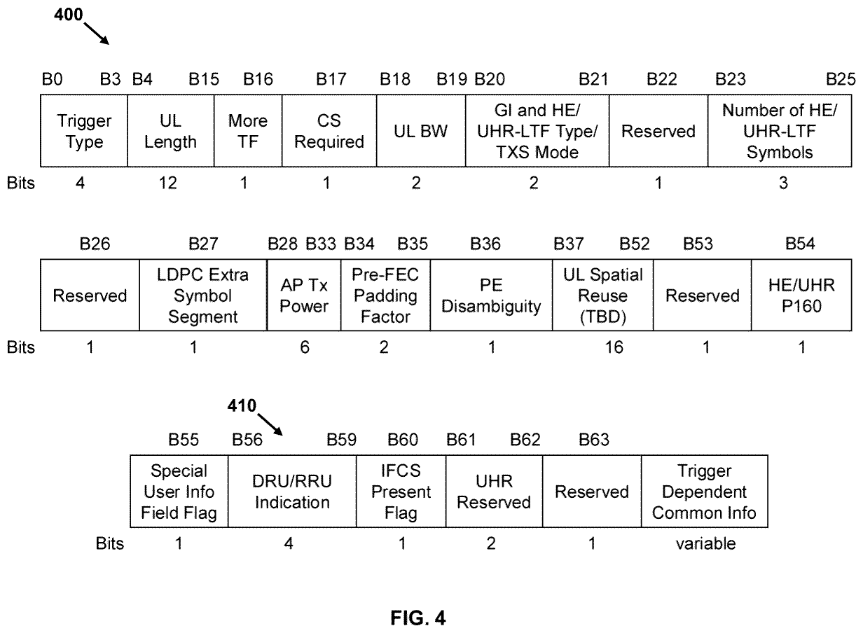

FIG. 3 is a simplified schematic diagram of a STA 112. As shown, the STA 112 includes at least one processing unit 202, at least one transceiver 204, at least one antenna or network interface controller (NIC) 206, one or more input/output components 210, at least one memory 212, and at least one other communication component 214. Each of these components 202 to 214 may be implemented as one or more circuits (such as one or more electronic circuits and/or one or more optical circuits). Alternatively, the ensemble of these components 202 to 214 may be implemented as one or more circuits. In various embodiments, the STA 112 may also include other components as needed or as desired.

The processing unit 202 is configured for performing various processing operations such as signal coding, data processing, power control, input/output processing, or any other functionalities to enable the STA 112 to access and join the communication system 100 and operate therein. The processing unit 202 may also be configured to implement some or all of the functionalities of the STA 112 described in this disclosure. The processing unit 202 may include a central processing unit (CPU), a microprocessor, a microcontroller, a digital signal processor, an accelerator, a graphic processing unit (GPU), a tensor processing unit (TPU), a FPGA, or an ASIC. Examples of the processing unit 202 may be an ARM^{®}microprocessor (ARM is a registered trademark of Arm Ltd., Cambridge, UK) manufactured by a variety of manufactures such as Qualcomm of San Diego, California, USA, under the ARM® architecture, an INTEL® microprocessor (INTEL is a registered trademark of Intel Corp., Santa Clara, CA, USA), an AMD® microprocessor (AMD is a registered trademark of Advanced Micro Devices Inc., Sunnyvale, CA, USA), and the like. In some embodiments, the processing unit 202 may execute computer-executable instructions or code stored in the memory 212 to perform various processes described below.

The at least one transceiver 204 may be configured for modulating data or other content for transmission by the at least one antenna 206 to communicate with an AP 102. The transceiver 204 is also configured for demodulating data or other content received by the at least one antenna 206. Each transceiver 204 may include any suitable structure for generating signals for wireless transmission and/or processing signals received wirelessly. Each antenna 206 may include any suitable structure for transmitting and/or receiving wireless signals. Although shown as a single functional unit, a transceiver 204 may be implemented separately as at least one transmitter and at least one receiver.

The one or more input/output components 210 is configured for interaction with a user or other devices in the communication system 100. Each input/output component 210 may include any suitable structure for providing information to or receiving information from a user and may be, for example, a speaker, a microphone, a keypad, a keyboard, a display, a touch screen, and/or the like.

The at least one memory 212 is configured for storing instructions executable by the processing unit 202 and data used, generated, or collected by the processing unit 202. For example, the memory 212 may store instructions of software, software systems, or software modules that are executable by the processing unit 202 for implementing some or all of the functionalities and/or embodiments of the STA 112 described herein. Each memory 212 may include any suitable volatile and/or non-volatile storage and retrieval components such as RAM, ROM, hard disk, optical disc, SIM card, solid-state memory modules, memory stick, SD memory card, and/or the like.

The at least one other communication component 214 is configured for communicating with other devices such as other STAs 112 via other communication means such as a radio link, a BLUETOOTH® link (BLUETOOTH is a registered trademark of Bluetooth Sig Inc., Kirkland, WA, USA), a wired sidelink, and/or the like. Examples of the wired sidelink may be a USB cable, a network cable, a parallel cable, a serial cable, and/or the like.

In some embodiments, a STA 112 may include a plurality of transceivers 204 and a plurality of antennas 206 for communication with an AP 102.

In the communication between the AP 102 and the STA 112, a transmission from the STA 112 to the AP 102 is usually denoted an uplink (UL) and the wireless channel used therefor is denoted an uplink channel. A transmission from the AP 102 to the STA 112 is usually denoted a downlink (DL) and the wireless channel used therefor is denoted a downlink channel.

In physical layer (PHY), the frequency-time resource of the channel 114 is partitioned into physical layer protocol data units (PPDUs; also called “packets”), and the AP 102 or STA 112 transmits data as PPDUs or packets. Suitable modulation technologies may be used for communication between the AP 102 and the STA 112. For example, in some embodiments, orthogonal frequency-division multiplexing (OFDM) may be used wherein the channel 114 is composed of a plurality orthogonal subcarriers for communication between the AP 102 and the STA 112. Moreover, as there are usually a plurality of STAs 112 in communication with a same AP 102, suitable multiple-access technologies may be used. For example, in some embodiments, orthogonal frequency-division multiple access (OFDMA) may be used for communication between the AP 102 and STAs 112.

According to the IEEE 802.11bn standard, DRUs with bandwidths (DBWs) of 20 MHz, 40 MHz, 60 MHz and 80 MHz are supported. Based on the IEEE 802.11bn standard, a DRU cannot be scheduled across the different 80 MHz frequency subblocks. A hybrid schedule (DRU+RRU) can be allowed across different 80 MHz frequency subblocks, that is, a DRU can be scheduled in an 80 MHz frequency subblock for one non-AP STA and an RRU (or a multiple RU (MRU)) can be scheduled in another frequency subblock(s) for another non-AP STA. IEEE 802.11bn standard also lacks support for multiple DRUs (non-contiguous multiple DRUs scheduled to one STA within a DBW). Furthermore, the 60 MHz in an 80 MHz frequency subblock is only supported within the first three 20 MHz blocks in the 80 MHz frequency subblock, that is, only one puncturing pattern is supported. In the IEEE 802.11bn standard, a DRU is applicable to a trigger based (TB) physical layer protocol data unit (PPDU), that is, the DRU scheduling information is indicated in a trigger frame.

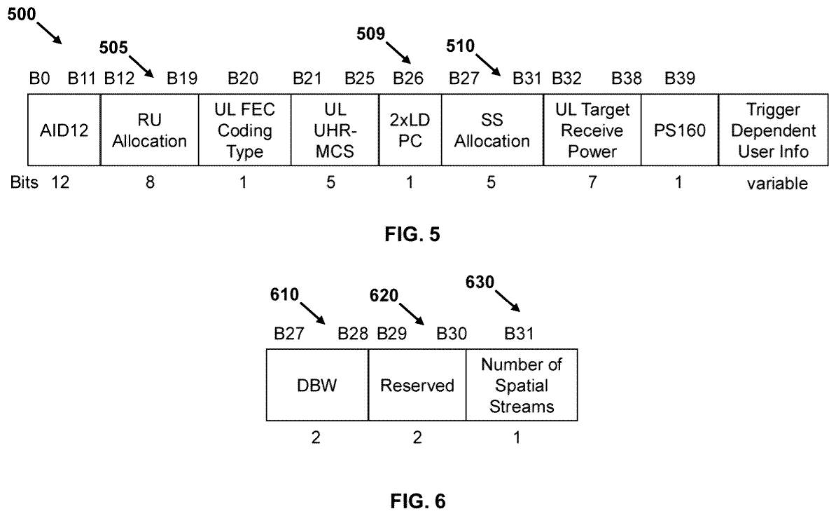

FIG. 4 is a simplified schematic diagram of a UHR variant common info field 400 of a UHR trigger frame, according to IEEE 802.11bn standard. DRU/RRU indication bits 410 include 4 bits B56-B59. The four DRU/RRU Indication bits are used like a bit map to indicate DRU and RRU scheduling in the trigger frame. For example, when the first bit of the four DRU/RRU indication bits 410 is set to zero, a 20 MHz DRU is scheduled in the corresponding 80 MHz frequency subblock, and the remaining three of the four DRU/RRU indication bits 410 are set to one.

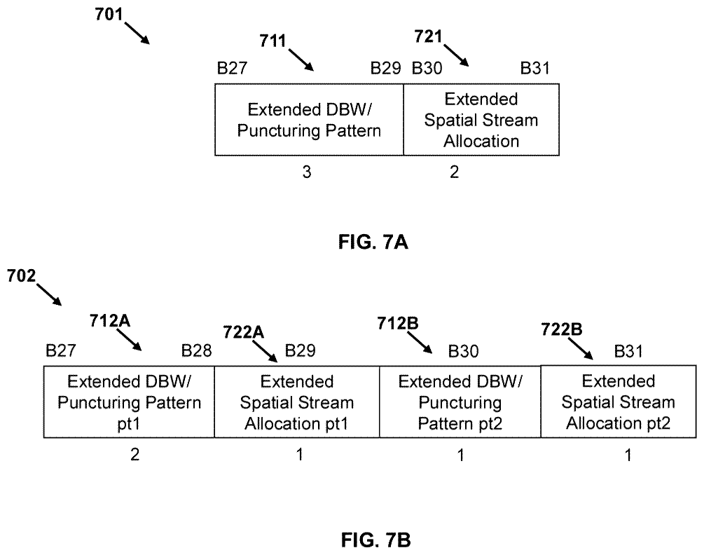

FIG. 5 shows the UHR variant user info field 500 of the UHR trigger frame, according to IEEE 802.11bn standard. The SS Allocation subfield 510 in the UHR variant user info field 500 is reduced to 5 bits, compared to 6 bits in a previous version of the extremely high throughput (EHT) variant user info field. The saved 1 bit B26 is used in the UHR variant user info field 500 for the 2× low density parity check (2×LDPC) indication 509.

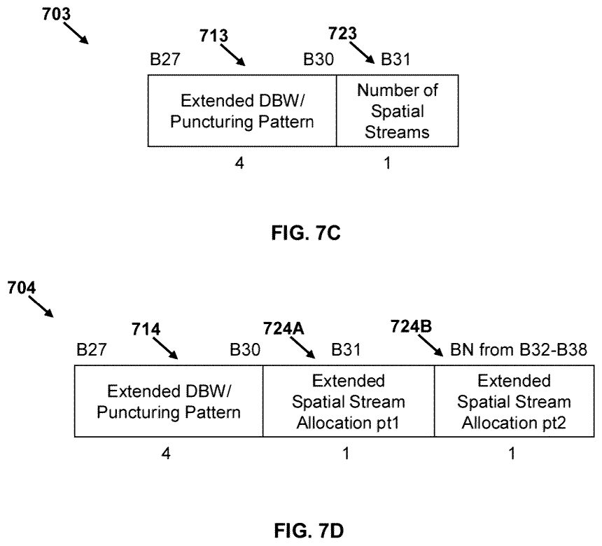

If the UHR variant user info field 500 is scheduled with a DRU, as indicated in the UHR variant common info field 400 of FIG. 4 using the DRU/RRU indication bits 410, then the 5 bit SS allocation subfield 510 in the UHR variant user info field 500 of FIG. 5 is allocated as shown in FIG. 6. With reference to FIG. 6, the first two bits B27 and B28 of the 5 bit SS allocation subfield 510 in the UHR variant user info field 500 of FIG. 5 are allocated for the DBW indication 610, the last bit B31 is allocated for the indication of the number of spatial streams 630 (either 1 or 2 streams), and the remaining two bits B29 and B30 are reserved bits 620.

The DBW indication bits 610 B27 and B28 of FIG. 6 indicate the DBW, which may be 20 MHz, 40 MHz, 60 MHz, or 80 MHz. The DRU allocation is indicated in the RU allocation subfield 505 that includes bits B12-B19 as shown in FIG. 5.

The overall DRU allocation in a PPDU BW, which has a frequency that is generally larger than the maximum frequency of 80 MHz that can be indicated in the UHR trigger frame according to IEEE 802.11bn standard, can be indicated using Equation (1) below:

k_{DRU_j}=k_{DRU_i}+K_{shift}(l) (1)

In Equation (1), k represents a subcarrier index, k_{DRU_i} represents the DRU allocation using bits B12 through B19, and K_{shift} (l) represents the frequency shift within the l'th frequency function block, which is 20 MHz, 40 MHz, or 80 MHz wide depending on the DBW. In case of 60 MHz DBW, the frequency function block size is 80 MHz. K_{shift} (l) and the index “l” can be determined as known in prior art.

Embodiments of the present disclosure are directed at utilizing the reserved bits 620 (B29 and B30) of FIG. 6 to indicate extended DBW.

In embodiments, the UHR variant user info field includes at least three extended DBW bits that jointly represent an extended DBW.

In embodiments, the UHR variant user info field includes at least two extended SS allocation bits that jointly represent an extended SS.

In some embodiments, the at least three extended DBW bits may include bit B27, bit B28 and one of bit B29 and bit B30. A bit may be selected from bit B29 and bit B30 such that the selected bit is absent from the at least three extended DBW bits. Such selected bit and bit B31 of the UHR variant user info field may be included in the at least two extended SS allocation bits.

In some embodiments, the at least two extended SS allocation bits may include two extended SS allocation bits. Such two extended SS allocation bits may be used to indicate four distinct numbers of SS, such as 1, 2, 4, and 8 spatial streams, or 1, 2, 3, and 4 spatial streams.

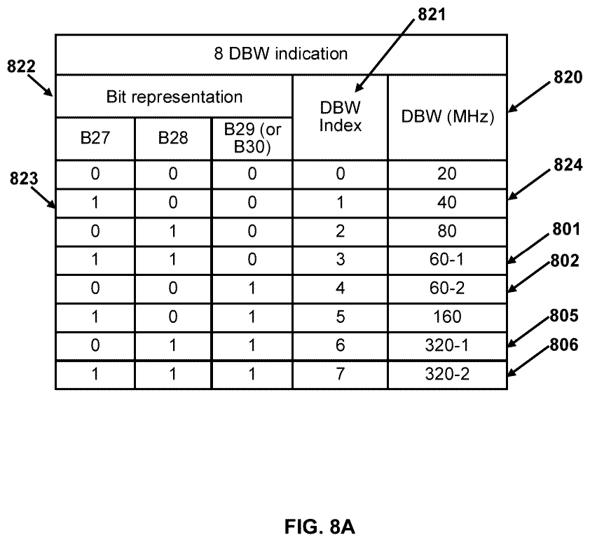

FIG. 7A shows a first example allocation 701 of bits B27 through B31 of the UHR variant user info field. In the first example allocation 701, three extended DBW bits 711 that include bits B27 through B29 are jointly used to represent extended DBW, and two extended SS allocation bits 721 that include bits B30 and B31 are jointly used to represent extended SS allocation. Notably, in this example the three extended BDW bits are contiguous, and the two extended SS allocation bits are contiguous.

FIG. 7B shows a second example allocation 702 of bits B27 through B31 of the UHR variant user info field. In the second example allocation 702, three extended DBW bits include two contiguous bits 712A B27 and B28, and bit B30 712B, which are jointly used to represent extended DBW. Two extended SS allocation bits include bit B29 722A and bit B31 722B and are jointly used to represent extended SS allocation. Notably, in this example only the two extended DBW bits B27 and B28 are contiguous.

In some embodiments, the at least three extended DBW bits may include bit B27, bit B28, bit B29 and bit B30.

In some embodiments, a bit may be selected from other bits of the UHR variant user info field, such as from bits B32 through bit B38. Such selected bit and bit B31 of the UHR variant user info field may be included in the at least two extended SS allocation bits.

In some embodiments, the at least two extended SS allocation bits may include three extended SS allocation bits if a greater number of spatial streams need to be indicated in a UHR trigger frame.

FIG. 7C shows a third example allocation 703 of bits B27 through B31 of the UHR variant user info field. In the third example allocation 703, four extended DBW bits 713 that include bits B27 through B30 are jointly used to represent extended DBW, and one number of SS bit 723 that includes bit B31 is used to represent the number of SS. Notably, in this example the four extended DBW bits are contiguous, and a single bit B31 from bits B27-B31 is allocated to the number of SS indication.

FIG. 7D shows a fourth example allocation 704 of bits B27 through B31 of the UHR variant user info field. In the fourth example allocation 704, four extended DBW bits 714 include bits B27-B30, which are jointly used to represent extended DBW. Two extended SS allocation bits include bit B31 724A and one bit 724B selected from bits B32-B38, which are jointly used to represent extended SS allocation. Notably, in this example the four extended DBW bits 714 are contiguous.

In an embodiment, with reference to FIG. 7D, the selected bit may be bit B32, in which case the two extended SS allocation bits include two bits B31 and B32 which are contiguous.

In embodiments, specific bit allocations other than those described herein with reference to non-limiting examples of FIGS. 7A-7D may be utilized. For example, other bits may be repurposed or other bits may become available in the UHR variant user info field of the UHR trigger frame in future Wi-Fi® standards.

In embodiments, the at least three extended DBW bits may be indicative of a puncturing pattern associated with a bandwidth indicated in the UHR trigger frame. The puncturing pattern may be selected from a plurality of puncturing patterns.

In some embodiments, if the extended DBW bits include three bits, which jointly allow for an indication of 8 distinct combinations of ones and zeroes, then the plurality of puncturing patterns may include up to 8 distinct puncturing patterns.

In some embodiments, if the extended DBW bits include four bits, which jointly allow for an indication of 16 distinct combinations of ones and zeroes, then the plurality of puncturing patterns may include up to 16 distinct puncturing patterns.

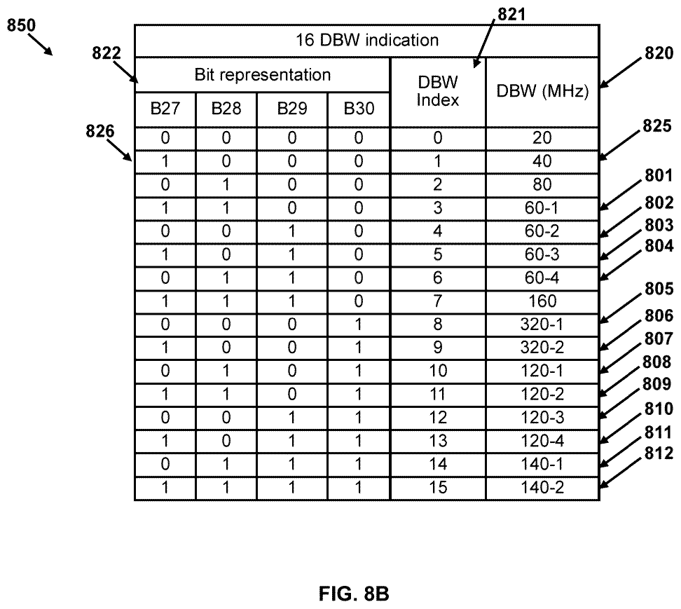

FIGS. 8A and 8B show tables of example allocations of three extended DBW bits 800 and example allocations of four extended DBW bits 850, respectively, to indicate the DBW and distinct puncturing patterns. Each DBW 820 can have a corresponding DBW index 821 assigned thereto and have a respective unique bit representation 822 among the allocated three extended DBW bits in FIG. 8A or four extended DBW bits in FIG. 8B. For example, 40 MHz DBW 825 in FIG. 8A may have a DBW index 821 of “1” and respective bit representation 823 where bit B27 has a value of “1”, bit B28 has a value of “0”, and a bit selected from bits B29 and B30 for the extended DBW bits has a value of “0”. In another example, 40 MHz DBW 825 in FIG. 8B may have a DBW index 821 of “1” and respective bit representation 826 where bit B27 has a value of “1”, bit B28 has a value of “0”, bit B29 has a value of “0” and bit B30 has a value of “0”.

The 60-1 MHz DBW 801 may, for example, represent 60 MHz in an 80 MHz frequency subblock with the last 20 MHz of the 80 MHz frequency subblock being punctured. Similarly, the 60-2 MHz DBW 802 may represent 60 MHz in an 80 MHz frequency subblock with the second last 20 MHz from the right most frequency in the 80 MHz frequency subblock being punctured. The 60-3 MHz DBW 803 may represent 60 MHz in an 80 MHz frequency subblock with the second 20 MHz from the left most frequency in the 80 MHz frequency subblock being punctured. The 60-4 MHz DBW 804 may represent 60 MHz in an 80 MHz frequency subblock with the first 20 MHz from the left most frequency in the 80 MHz frequency subblock being punctured.

Further reference to FIG. 8A, the 320-1 MHz DBW 805 and 320-2 MHz DBW 806 may represent the same frequency band as the EHT channel BW (CBW) indication. For example, the channel number of the center frequency may be 31, 95, 159 for 320-1 MHz DBW 805, and 63, 127 and 191 for the 320-2 MHz DBW 806.

Similarly, the 120-1 MHz DBW 807, 120-2 MHz DBW 808, 120-3 MHz DBW 809 and 120-4 MHz DBW 810 may represent different 40 MHz puncturing patterns of a 160 MHz frequency subblock, and, additionally, 140-1 MHz DBW 811 and 140-2 MHz DBW 812 may, for example, represent different 20 MHz puncturing patterns of the 160 MHz frequency subblock. It is within the scope of the present disclosure to provide additional various combinations of puncturing patterns in 160 MHz DBW and 320 MHz DBW as well, which may be configured in a similar manner as defined in the examples already discussed.

Embodiments disclosed herein enable indicating, for example in a future Wi-Fi® system, an extended DBW greater than 80 MHz with or without sub-band puncturing.

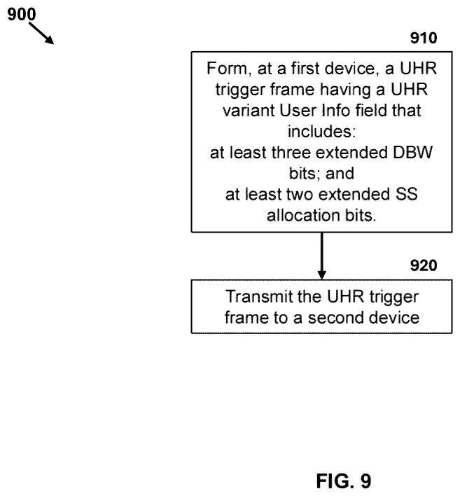

FIG. 9 schematically shows a first example method 900, according to embodiments of the present disclosure. The first method 900 includes a first step 910 of forming, at a first device (e.g., an AP) in a wireless network, a UHR trigger frame having a UHR variant user info field that includes at least three extended DBW bits that jointly represent an extended DBW, and at least two extended SS allocation bits that jointly represent an extended SS to be used by a second device (e.g., a STA) in the wireless network. The first method 900 includes a second step 920 of transmitting, by the first device, the UHR trigger frame to the second device.

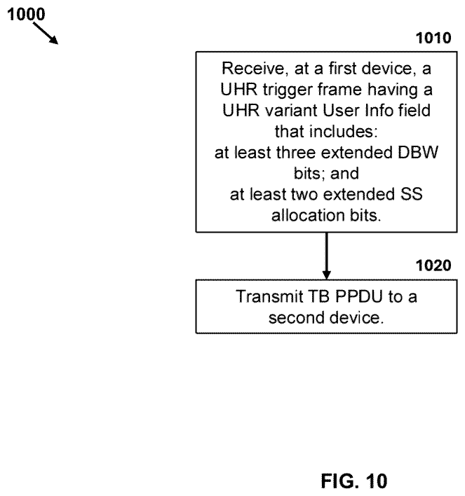

FIG. 10 schematically shows a second example method 1000, according to embodiments of the present disclosure. The second method 1000 includes a first step 1010 of receiving, at a first device (e.g., a STA) in a wireless network, a UHR trigger frame having a UHR variant user info field that includes at least three extended DBW bits that jointly represent an extended DBW, and at least two extended SS allocation bits that jointly represent an extended SS to be used by the first device (e.g., a STA) in the wireless network. The second method 1000 includes a second step 1020 of transmitting, by the first device, a TB PPDU to another device (e.g., an AP). The transmitted TB PPDU is formed at the first device according to the received UHR trigger frame and uses the extended SS stream as indicated in the received UHR trigger frame using the at least two extended SS allocation bits, and uses a DBW and a puncturing pattern as indicated in the received UHR trigger frame using the at least three extended DBW bits.

Using the embodiments disclosed herein can advantageously mitigate the implementation burden in supporting non-contiguous 60 MHz DBWs. For example, some existing tone plans support a universal 60 MHz DBW tone plan which can accommodate various embodiments of the puncturing patterns disclosed herein in an 80 MHz DBW with a simple frequency shift.

Embodiments described herein include utilizing one or two reserved bits (e.g., 620 in FIG. 6) following the DBW subfield (e.g., 610 in FIG. 6) in the UHR variant user info field (e.g., as shown in FIG. 5) for the indication of the extended DBW jointly with the existing two-bit DBW indication (e.g., 610 in FIG. 6) in the UHR variant user info field. Using the at least three extended DBW bits to indicate extended DBW advantageously enables to indicate different puncturing patterns, for example, to include more non-contiguous 60 MHz DBW puncturing patterns in the extended DBW bits. The at least three extended DBW bits can be used to indicate spawned punctured DBW patterns in the extended DBW/Puncturing Pattern subfield.

Embodiments described herein include utilizing one or two of the five SS allocation bits (e.g., 510 in FIG. 5) in the UHR variant user info field for the indication of the extended SS allocation. Where one of the five SS allocation bits (e.g., 510 in FIG. 5) is utilized, another at least one bit may be utilized from other bits of the UHR variant user info field, for example from bits B32-B38, to indicate the extended SS allocation jointly with the one of the five SS allocation bits.

Herein, the term “predefined” (for example, a “predefined” item such as a “predefined” parameter) refers to an item defined before the method disclosed herein is performed (for example, defined as a system design parameter such as defined by relevant standards).

Herein, the term “preconfigured” (for example, a “preconfigured” item such as a “preconfigured” parameter) refers to an item configured by a suitable apparatus before a certain even occurs.

Herein, use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

Herein, various embodiments are described. In various embodiments, the methods disclosed herein may be implemented as hardware, software, firmware, or a combination thereof, and may be implemented in any suitable form. Depending on the functionalities of various features of the methods disclosed herein, some features may be implemented on the network side (such as in one or more APs), some other features may be implemented on the STA side, and/or yet some other features may be implemented on both the AP and the STA sides. Depending on the functionalities of various features of the methods disclosed herein, some features may be implemented on the transmitting side (such as in one or more APs and/or one or more STAs for transmission), some other features may be implemented on the receiving side (such as in one or more APs and/or one or more STAs for receiving), and/or yet some other features may be implemented on both the transmitting and the receiving sides.

For example, in some embodiments, the methods disclosed herein may be implemented as computer-executable instructions stored in one or more non-transitory computer-readable storage devices (in the form of software, firmware, or a combination thereof) such that, the instructions, when executed, may cause one or more physical components such as one or more circuits to perform the methods disclosed herein.

For example, in some embodiments, an apparatus including one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some embodiments, an apparatus may not have any processors or computer-readable storage devices or media. Rather, the apparatus may include any other suitable physical or virtual (explained below) components for implementing the methods disclosed herein.

In some embodiments, the computer-executable instructions that implement the methods disclosed herein may be one or more computer programs, one or more program products, or a combination thereof.

In some embodiments, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Those skilled in the art will appreciate that the various embodiments and/or features disclosed herein may be customized and/or combined as needed or desired. Moreover, although embodiments have been described above with reference to the accompanying drawings, those of skill in the art will appreciate that variations and modifications may be made without departing from the scope thereof as defined by the appended claims.

What is claimed is:

1. A method comprising:
forming, at a first device in a wireless network, an ultra-high reliability (UHR) trigger frame having a UHR variant User Info field that includes:
at least three extended distributive resource unit bandwidth (DBW) bits, the at least three extended DBW bits jointly representing an extended DBW; and
at least two extended spatial stream (SS) allocation bits, the at least two extended SS allocation bits jointly representing an extended SS to be used by a second device in the wireless network; and
transmitting, by the first device, the UHR trigger frame to the second device.

2. The method of claim 1, wherein the at least three extended DBW bits include bit 27 and bit 28 and one of bit 29 and bit 30, the at least three extended DBW bits are indicative of a puncturing pattern selected from a plurality of puncturing patterns, the puncturing pattern associated with a bandwidth (BW) indicated in the UHR trigger frame, wherein the plurality of puncturing patterns includes 8 distinct puncturing patterns.

3. The method of claim 2, wherein a bit is selected from bit 29 and bit 30, the selected bit being absent from the at least three extended DBW bits, wherein the at least two extended SS allocation bits include bit 31 of the UHR variant user info field and the selected bit.

4. The method of claim 1, wherein the at least three extended DBW bits include bit 27 and bit 28 and bit 29 and bit 30, the at least three extended DBW bits are indicative of a puncturing pattern selected from a plurality of puncturing patterns, the puncturing pattern associated with a bandwidth (BW) indicated in the UHR trigger frame, wherein the plurality of puncturing patterns includes 16 distinct puncturing patterns.

5. The method of claim 4, wherein one bit is selected from bit 32 through bit 38, wherein the at least two extended SS allocation bits include bit 31 of the UHR variant User Info field and the selected bit.

6. The method of claim 5, wherein the selected bit is bit 32.

7. The method of claim 1, wherein the extended DBW bits are contiguous.

8. A method, comprising:
receiving, at a first device in a wireless network, an ultra-high reliability (UHR) trigger frame having a UHR variant User Info field that includes:
at least three extended distributive resource unit bandwidth (DBW) bits, the at least three extended DBW bits jointly representing an extended DBW; and
at least two extended spatial stream (SS) allocation bits, the at least two extended SS allocation bits jointly representing an extended SS to be used in transmitting, by the first device, a trigger based (TB) physical layer protocol data unit (PPDU) based on the UHR trigger frame; and
transmitting, by the first device, the TB PPDU, to a second device in the wireless network.

9. The method of claim 8, wherein the at least three extended DBW bits include bit 27 and bit 28 and one of bit 29 and bit 30, the at least three extended DBW bits are indicative of a puncturing pattern selected from a plurality of puncturing patterns, the puncturing pattern associated with a bandwidth (BW) indicated in the UHR trigger frame, wherein the plurality of puncturing patterns includes 8 distinct puncturing patterns.

10. The method of claim 9, wherein a bit is selected from bit 29 and bit 30, the selected bit being absent from the at last three extended DBW bits, wherein the at least two extended SS allocation bits include bit 31 of the UHR variant user info field and the selected bit.

11. The method of claim 8, wherein the at least three extended DBW bits include bit 27 and bit 28 and bit 29 and bit 30, the at least three extended DBW bits are indicative of a puncturing pattern selected from a plurality of puncturing patterns, the puncturing pattern associated with a bandwidth (BW) indicated in the UHR trigger frame, and the plurality of puncturing patterns includes 16 distinct puncturing patterns.

12. The method of claim 11, wherein one bit is selected from bit 32 through bit 38, wherein the at least two extended SS allocation bits include bit 31 of the UHR variant user info field and the selected bit.

13. The method of claim 12, wherein the selected bit is bit 32.

14. The method of claim 8, wherein the extended DBW bits are contiguous.

15. An apparatus in a wireless network, the apparatus comprising a processor and memory, the memory including machine executable instructions which when executed by the processor configure the apparatus to:
form, at a first device in a wireless network, an ultra-high reliability (UHR) trigger frame having a UHR variant User Info field that includes:
at least three extended distributive resource unit bandwidth (DBW) bits, the at least three extended DBW bits jointly representing an extended DBW; and
at least two extended spatial stream (SS) allocation bits, the at least two extended SS allocation bits jointly representing an extended SS to be used by a second device in the wireless network; and
transmit, by the first device, the UHR trigger frame to the second device.

16. The apparatus of claim 15, wherein the at least three extended DBW bits include bit 27 and bit 28 and one of bit 29 and bit 30, the at least three extended DBW bits are indicative of a puncturing pattern selected from a plurality of puncturing patterns, the puncturing pattern associated with a bandwidth (BW) indicated in the UHR trigger frame, wherein the plurality of puncturing patterns includes 8 distinct puncturing patterns.

17. The apparatus of claim 16, wherein a bit is selected from bit 29 and bit 30, the selected bit being absent from the at least three extended DBW bits, wherein the at least two extended SS allocation bits include bit 31 of the UHR variant user info field and the selected bit.

18. The apparatus of claim 15, wherein the at least three extended DBW bits include bit 27 and bit 28 and bit 29 and bit 30, the at least three extended DBW bits are indicative of a puncturing pattern selected from a plurality of puncturing patterns, the puncturing pattern associated with a bandwidth (BW) indicated in the UHR trigger frame, wherein the plurality of puncturing patterns includes 16 distinct puncturing patterns.

19. The apparatus of claim 18, wherein one bit is selected from bit 32 through bit 38, wherein the at least two extended SS allocation bits include bit 31 of the UHR variant User Info field and the selected bit.

20. The apparatus of claim 19, wherein the selected bit is bit 32.
